(19) United States
(12) Patent Application Publication
(10) Pub. No.: US 2013/0107696 A1
(43) Pub. Date: May 2, 2013

(54) LOCATION-BASED ROUTING APPARATUS AND METHOD USING LQI

(71) Applicants: Young Hwan CHOI, Daejeon (KR); Sang Keun YOO, Chungcheongnam-do (KR); Yong Woon KIM, Chungcheongnam-do (KR); Hyoung Jun KIM, Daejeon (KR)

(72) Inventors: Young Hwan CHOI, Daejeon (KR); Sang Keun YOO, Chungcheongnam-do (KR); Yong Woon KIM, Chungcheongnam-do (KR); Hyoung Jun KIM, Daejeon (KR)

(73) Assignee: Electronics and Telecommunications Research Institute, Daejeon (KR)

(21) Appl. No.: 13/614,442

(22) Filed: Sep. 13, 2012

(30) Foreign Application Priority Data
Nov. 2, 2011 (KR) 10-2011-0113443

(51) Int. Cl. H04L 12/56; H04L 29/14

(52) U.S. Cl. 370/216; 370/400

(57) ABSTRACT

Disclosed is a location-based routing apparatus and method using a link quality index (LQI). The location-based routing apparatus using an LQI may include a determining unit to determine, when a packet received from a first node is a data packet, M candidate neighboring nodes among second nodes different from the first node based on an LQI of the second nodes, wherein M is a natural number, and a processor to select, based on a distance from a receiving node corresponding to a destination of the packet, one neighboring node among the determined candidate neighboring nodes, and to transmit the packet to the selected neighboring node.

### CROSS-REFERENCE TO RELATED APPLICATION

This application claims the priority benefit of Korean Patent Application No. 10-2011-0113443, filed on Nov. 2, 2011, in the Korean Intellectual Property Office, the disclosure of which is incorporated herein by reference.

### BACKGROUND

1. Field of the Invention

Exemplary embodiments of the present invention relate to a routing apparatus and method that may determine candidate neighboring nodes for packet delivery using a link quality index (LQI), may select a neighboring node for each packet to be transmitted among the determined candidate neighboring nodes, and may transmit the packet to the selected neighboring node, to prevent a packet overload.

2. Description of the Related Art

A network system may enable packet transmission between nodes using various routing methods. For example, the network system may enable packet transmission between nodes using a location information-based routing method. That is, the network system may select a neighboring node located closest to a receiving node among neighboring nodes present within a radio radius of a transmitting node and may deliver data from the transmitting node to the selected neighboring node. Unlike an identification (ID) information-based routing method, the location information-based routing method may allow the network system to eliminate the need for a control packet for routing path setup and release, routing path error recovery, and the like, thereby reducing a wireless bandwidth and preventing packet congestion.

According to the location information-based routing method when a relay node participating in routing between a transmitting node and a receiving node does not have mobility, the relay node participating in routing, once before, needs to continue participation while data transmission is made between the same transmitting node and the same receiving node. That is, since the location information-based routing method has a result that may be obtained by using only single routing information, packet transmission may be concentrated on the same node, resulting in a packet overload. Thus, there exists a high possibility of data transmission failure being caused by packet congestion and packet collision. Also, as the distance between nodes increases, a link quality index (LQI) may decrease while increasing a failure rate in packet transmission between the nodes.

### SUMMARY

An aspect of the present invention provides a method that may determine candidate neighboring nodes for packet delivery using a link quality index (LQI), may select a neighboring node for each packet to be transmitted among the determined candidate neighboring nodes, and may transmit the packet to the selected neighboring node, to reduce a failure rate in packet delivery and prevent a packet overload.

Another aspect of the present invention also provides a method that may select a neighboring node for packet transmission among candidate neighboring nodes in consideration of a distance from a receiving node corresponding to a destination of a packet, to enable routing via a relatively short routing path.

According to an aspect of the present invention, there is provided a routing apparatus including a determining unit to determine, when a packet received from a first node is a data packet, M candidate neighboring nodes among second nodes different from the first node based on an LQI of the second nodes, wherein M is a natural number, and a processor to select, based on a distance from a receiving node corresponding to a destination of the packet, one neighboring node among the determined candidate neighboring nodes, and to transmit the packet to the selected neighboring node.

According to another aspect of the present invention, there is provided a routing method including determining, when a packet received from a first node is a data packet, M candidate neighboring nodes among second nodes different from the first node based on an LQI of the second nodes, wherein M is a natural number, and selecting, based on a distance from a receiving node corresponding to a destination of the packet, one neighboring node among the determined candidate neighboring nodes, and transmitting the packet to the selected neighboring node.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an example of routing in a network system including a location-based routing apparatus using a link quality index (LQI) according to an embodiment of the present invention;

FIG. 2 is a diagram illustrating a configuration of a location-based routing apparatus using an LQI according to an embodiment of the present invention;

FIG. 3 is a diagram illustrating a format of a data packet;

FIG. 4 is a diagram illustrating a format of an acknowledgement message;

FIG. 5 is a diagram illustrating a format of a hello message; and

FIG. 6 is a flowchart illustrating a location-based routing method using an LQI according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Exemplary embodiments provide a location-based routing apparatus and method using a link quality index (LQI).

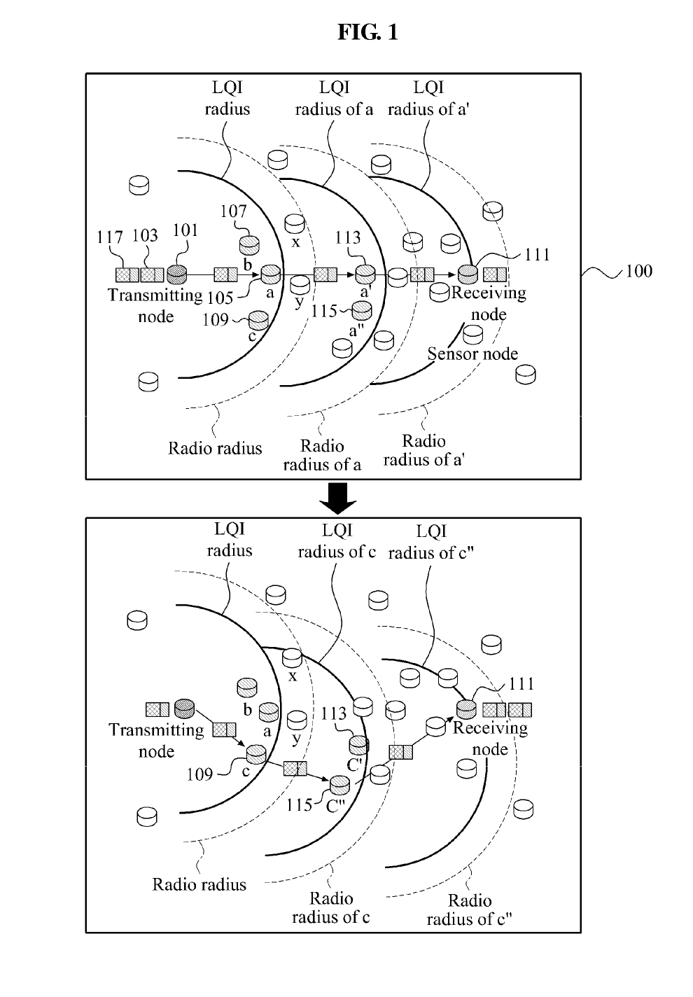

FIG. 1 is a diagram illustrating an example of routing in a network system 100 including a location-based routing apparatus using an LQI according to an embodiment of the present invention.

Referring to FIG. 1, a network system 100 may include a plurality of nodes. Here, each node may correspond to a routing apparatus or may include a routing apparatus. Also, each node may provide information about the node to a neighboring node by periodically transmitting a state message, for example, a hello message.

That is, a transmitting node 101 may transmit and receive a state message to and from the other node. The transmitting node 101 may generate an identification (ID) of the transmitting node 101 using location information of the transmitting node 101. For example, when coordinates as location information is (100, 300), the transmitting node 101 may generate an ID 100:300.

An ID generation algorithm for a node may be represented by Table 1.

TABLE 1
Function getNodeID (X Coordinate value, Y Coordinate value) {

x = Convert integer value into character string (X Coordinate value) ;
y = Convert integer value into character string (Y Coordinate value) ;
ID = Combine character strings (x+“:”+y) ;

}

Also, when the transmitting node 101 receives a first packet 103, the transmitting node 101 may verify whether the received first packet 103 is a data packet or a state message. When the received first packet 103 is a state message comprising a node ID, the transmitting node 101 may generate information about a node that has transmitted the first packet 103, including an ID of the node, location information of the node, for example, x and y coordinates, an LQI of the node, and an effective time for information, based on the state message, and may store the generated information of the node in a database. In this instance, after the lapse of the effective time for information, the transmitting node 101 may delete the information about the node from the database.

The transmitting node 101 may store, in the database, the information about the node, for example, shown in Table 2.

TABLE 2

| | Node location | | | |
|---|---|---|---|---|
| ID of | coordinate | | LQI of | |
| neighboring | information | | neighboring | Effective time |
| node | x coordinate | y coordinate | node | for information |
| 1:2 | 1 | 2 | 100 | 60 sec |

When the received first packet 103 is verified to be a data packet, the transmitting node 101 may determine candidate neighboring nodes 105, 107, and 109 among a plurality of nodes, aside from the transmitting node 101. In this instance, the transmitting node 101 may determine, to be a candidate neighboring node, a node having an LQI with the transmitting node 101 greater than or equal to a predetermined value. Accordingly, an environment in which a transmission failure rate reduces may be ensured.

The transmitting node 101 may select, based on a distance from a receiving node corresponding to a destination of the first packet 103, the first neighboring node 105 among the determined candidate neighboring nodes 105, 107, and 109, and may transmit the first packet 103 to the selected first neighboring node 105. In this instance, the transmitting node 101 may measure a distance from the receiving node 111 for each of the candidate neighboring nodes 105, 107, and 109, using a receiver ID or receiver location information extracted from the first packet 103 and an ID or location information of each of the candidate neighboring nodes 105, 107, and 109 obtained from the database. That is, the transmitting node 101 may select the first neighboring node 105 having a relatively short distance from the receiving node 111, and may transmit the first packet 103 to the first neighboring node 105.

In this instance, when the first packet 103 received from the transmitting node 101 is a data packet, the first neighboring node 105 may extract, from the first packet 103, at least one of an ID of the transmitting node 101 and an ID of the first packet 103, and may provide information about transmission completion of the first packet 103 to the transmitting node 101 by transmitting an acknowledgement message comprising the extracted ID to the transmitting node 101. Also, the first neighboring node 105 may record an ID of the first neighboring node 105 in a relay sender ID included in a header of the first packet 103, and may record, in a relay receiver ID, an ID of a neighboring node 113 selected among neighboring nodes 113 and 115 determined for delivery of the first packet 103.

When the transmitting node 101 receives the acknowledgement message to the first packet 103 from the first neighboring node 105 within a predetermined effective time, the transmitting node 101 may complete transmission of the first packet 103. When the transmitting node 101 fails to receive the acknowledgement message to the first packet 103 from the first neighboring node 105 within a predetermined effective time, the transmitting node 101 may re-transmit the first packet 103 to the first neighboring node 105. When a number of re-transmission times is greater than or equal to a predetermined value, the transmitting node 101 may remove the first neighboring node 105 from the candidate neighboring nodes 105, 107, and 109.

Also, when the transmitting node 101 receives a second packet 117 that is a data packet, the transmitting node 101 may select the second neighboring node 109 which is different from the first neighboring node 105 among the determined candidate neighboring nodes 105, 107, and 109, and may transmit the second packet 117 to the selected second neighboring node 109, to prevent a packet overload caused by a concentration of packet transmission on one neighboring node. In this instance, the transmitting node 101 may select the second neighboring node 109 having a relatively short distance from the receiving node 111 corresponding to a destination of the second packet 117, among the candidate neighboring nodes 107 and 109 aside from the first neighboring node 105, may transmit the second packet 117 to the selected second neighboring node 109, and may receive an acknowledgement message to the second packet 117 from the second neighboring node 109.

An algorithm for determining candidate neighboring nodes among a plurality of nodes and selecting a neighboring node for packet transmission among the determined candidate neighboring nodes may be represented by Table 3.

TABLE 3
Function getRelayNode {

neighbor_num=number of neighboring nodes ;
neighbor[n]=list of neighboring nodes ;
relay_num=0;//number of determined transmission relay
neighboring nodes
relay_[n]=0;//list of determined transmission relay neighboring
nodes
while (neighbor_num) {

```
if(neighbor[neighbor_num].LQI< effective LQI) continue ;
else if(distance[neighbor[neighbor_num], receiver) ==
  shortest path between nodes included in neighboring nodes,
  but not relay nodes ? ){
```

relay[relay_num].add(neighbor[neighbor_num]) ;
relay_num=relay_num+1 ;

}

neighbor_num=neighbor_num−1 ;
}
rnd=randomly selected number greater than 0 and smaller
than relay_num ;
finally selected relay node=relay[rnd] ;
return finally selected relay node ;

}

Although the routing method is described based on the transmitting node for concise description, the routing method is not limited in this regard and may be applied to another node in a similar manner.

Accordingly, the network system 100 including the location-based routing apparatus using an LQI according to an embodiment of the present invention may transmit the first packet 103 to the receiving node 111 through the transmitting node 101, the first neighboring node 105, and the first neighboring node_#1 113, and may transmit the second packet 117 to the receiving node 111 through the transmitting node 101, the second neighboring node 109, and the second neighboring node_#1 115.

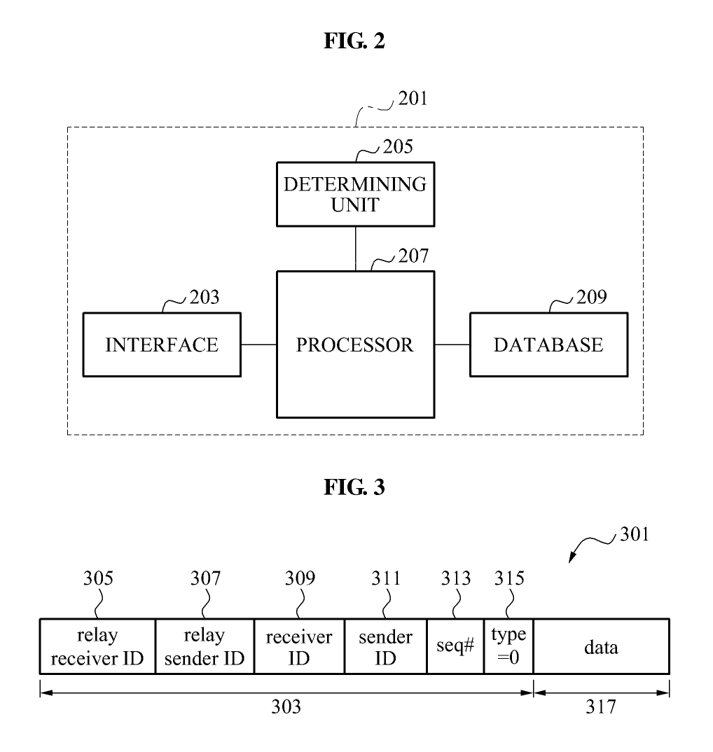

FIG. 2 is a diagram illustrating a configuration of a location-based routing apparatus 201 using an LQI according to an embodiment of the present invention.

Referring to FIG. 2, the location-based routing apparatus 201 using an LQI may include an interface 203, a determining unit 205, a processor 207, and a database 209.

The interface 203 may receive a packet from a plurality of nodes including a first node and a second node and verify whether the received packet is a data packet or a state message.

When the received packet is a state message, for example, a hello message, comprising a node ID, the interface 203 may generate information about the node based on the state message and may store the generated information in a database 209. In this instance, the interface 203 may generate, as the information about the node, for example, an ID of the node, location information of the node, for example, x and y coordinates, an LQI of the node, and an effective time for information.

When the packet received from the first node is verified to be a data packet by the interface 203, the determining unit 205 may determine M candidate neighboring nodes among second nodes different from the first node based on an LQI of the second nodes, that is, an LQI between the routing apparatus 201 and the second nodes, wherein M is a natural number. That is, the determining unit 205 may determine the second node having an LQI greater than or equal to a predetermined value to be the candidate neighboring node. In this instance, the determining unit 205 may use an LQI for each node stored in the database 209.

The processor 207 may select, based on a distance from a receiving node corresponding to a destination of the packet, one neighboring node among the determined candidate neighboring nodes, and transmit the packet received through the interface 203 to the selected neighboring node. In this instance, the processor 207 may measure the distance from the receiving node for each of the candidate neighboring nodes, using a receiver ID or receiver location information extracted from the packet and an ID or location information of each neighboring node obtained from the database 209. That is, the processor 207 may select a neighboring node having a relatively short distance from the receiving node among the determined candidate neighboring nodes and may transmit the packet to the selected neighboring node.

Also, the processor 207 may select a neighboring node different from a neighboring node transmitting a previous packet and may transmit the packet to the selected neighboring node. That is, when a first data packet is received from the first node and a second data packet different from the first data packet is received, the processor 207 may transmit the second data packet to a second neighboring node different from the first neighboring node transmitting the first data packet. For example, the processor 207 may arrange three candidate neighboring nodes based on a distance from a receiving node, that is, the processor 207 may sequentially arrange a first neighboring node, a second neighboring node, and a third neighboring node in an ascending order of a distance from a receiving node, and transmit a first packet to the first neighboring node, a second packet to the second neighboring node, and a third packet to the third neighboring node in an alternate manner.

Also, when the packet received from the first node is a data packet, the processor 207 may extract at least one of an ID of the first node and a packet ID from the packet, and may provide information about transmission completion of the packet to the first node by transmitting an acknowledgement message comprising the extracted ID to the first node.

When the processor 207 fails to receive the acknowledgement message to the packet from the neighboring node transmitting the packet within a predetermined effective time, the processor 207 may re-transmit the packet to the neighboring node. In this instance, when a number of re-transmission times is greater than or equal to a predetermined value, the processor 207 may remove the neighboring node from the candidate neighboring nodes and may transmit the packet to the other neighboring node.

The database 209 may store information about a plurality of nodes.

FIG. 3 is a diagram illustrating a format of a data packet 301.

Referring to FIG. 3, the data packet 301 may include packet header information 303 and data information n317.

The packet header information 303 may a relay receiver ID 305, a relay sender ID 307, a receiver ID 309, a sender ID 311, a packet number seq#313, and a type 315.

The relay receiver ID 305 may correspond to an ID, for example, an address value, of a receiving node, that is, a finally selected neighboring node, on a link through which a data packet passes. That is, the relay receiver ID 305 may correspond to an ID, for example, an address value, of a relay node from which the data packet has been delivered, and when the packet is received at a final receiving node, may have the same value as the receiver ID 309.

The relay sender ID 307 may correspond to an ID, for example, an address value, of a relay sender node on a link through which a data packet passes. That is, the relay sender ID 307 may correspond to an ID, for an address value, of a relay node to which the data packet has been delivered. When the packet is transmitted from an initial transmitting node, the relay sender ID 307 may have the same value as the sender ID 311.

The receiver ID 309 may correspond to an ID, for example, an address value, of a final receiving node that finally receives the packet.

The sender ID 311 may correspond to an ID, for example, an address value, of an initial transmitting node that initially transmits the packet.

The packet number seq#313 may correspond to an ID of the packet and may indicate an order of the packet.

The type 315 may correspond to a type of a packet, that is, a data packet, and may indicate, for example, 0.

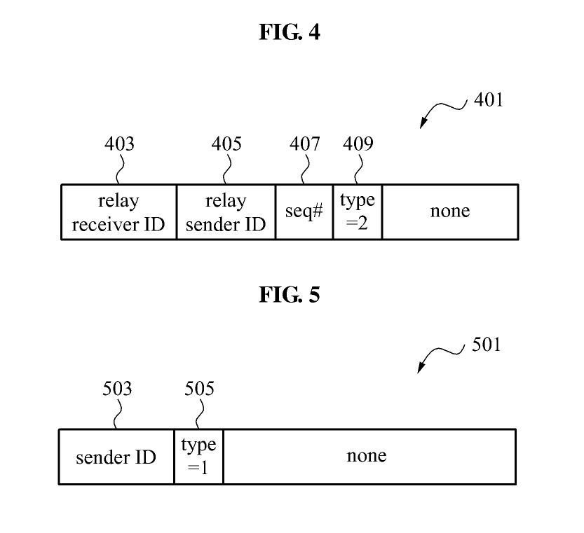

FIG. 4 is a diagram illustrating a format of an acknowledgement message 401.

Referring to FIG. 4, the acknowledgement message 401 may include a relay receiver ID 403, a relay sender ID 405, a packet number seq#407, and a type 409.

The relay receiver ID 403 may correspond to an ID of a previous relay node delivering a data packet corresponding to a packet number.

The relay sender ID 405 may correspond to an ID of a node, to which a data packet corresponding to a packet number is delivered.

The packet number seq#407 may correspond to an ID of a packet and may indicate an order of the packet.

The type 409 may correspond to a type of the packet, that is, an acknowledgement message, and may indicate, for example, a value of 2.

FIG. 5 is a diagram illustrating a format of a hello message 501.

Referring to FIG. 5, the hello message 501 may include a sender ID 503 and a type 505.

The sender ID 503 may correspond to an ID of a node transmitting the hello message 501.

The type 505 may correspond to a type of a packet, that is, a hello message, and may indicate, for example, a value of 1.

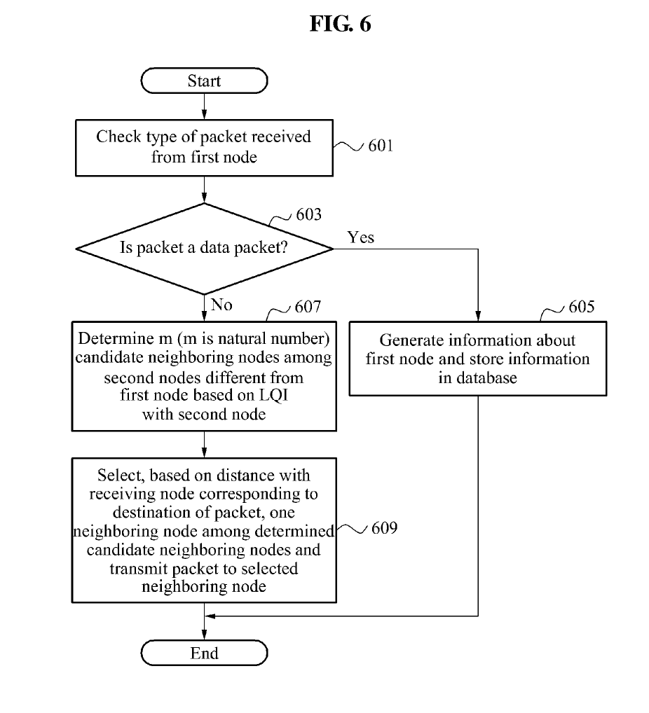

FIG. 6 is a flowchart illustrating a location-based routing method using an LQI according to an embodiment of the present invention.

Referring to FIG. 6, in operation 601, the routing apparatus may receive a packet from a first node and may check a type of the received packet. That is, the routing apparatus may verify whether the packet is a data packet or a state message.

When the packet received from the first node is a data packet, the routing apparatus may extract at least one of an ID of the first node and a packet ID from the packet and may provide information about completion of transmission of the packet to the first node by transmitting an acknowledgement message comprising the extracted ID to the first node.

When the packet is not a data packet, that is, the packet is a state message, for example, a hello message in operation 603, the routing apparatus may generate information about the first node based on the state message and may store the generated information in the database, in operation 605. In this instance, the routing apparatus may generate, as the information about the node, for example, an ID of the node, location information of the node, for example, x and y coordinates, an LQI of the node, and an effective time for information.

Also, the routing apparatus may periodically receive a state message from a second node different from the first node, may generate information about the second node, and may store the generated information about the second node in the database.

When the packet is a data packet in operation 603, the routing apparatus may determine M candidate neighboring nodes among second nodes different from the first node, wherein M is a natural number, based on an LQI of the second nodes, that is, an LQI between the routing apparatus and the second nodes, in operation 607. In this instance, the routing apparatus may determine a second node having an LQI greater than or equal to a predetermined value to be the candidate neighboring node, using an LQI for each node stored in the database.

In operation 609, the routing apparatus may select one neighboring node among the determined candidate neighboring nodes based on a distance from a receiving node corresponding to a destination of the packet, and may transmit the packet to the selected neighboring node.

In this instance, the routing apparatus may measure a distance from the receiving node for each of the candidate neighboring nodes, using a receiver ID or receiver location information extracted from the packet and an ID or location information of each candidate neighboring node obtained from the database. That is, the routing apparatus may select a neighboring node having a relatively short distance from the receiving node among the determined candidate neighboring nodes, and may transmit the packet to the selected neighboring node.

Also, the routing apparatus may select a neighboring node different from a neighboring node transmitting a previous packet and may transmit the packet to the selected neighboring node. That is, when a first data packet is received from the first node and a second data packet different from the first data packet is received, the routing apparatus may transmit the second data packet to a second neighboring node different from the first neighboring node transmitting the first data packet.

When the routing apparatus fails to receive an acknowledgement message to the packet from the neighboring node transmitting the packet within a predetermined effective time, the routing apparatus may re-transmit the packet to the neighboring node. Also, when a number of re-transmission times is greater than or equal to a predetermined value, the routing apparatus may remove the neighboring node from the candidate neighboring nodes and may transmit the packet to the other neighboring node.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard discs, floppy discs, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

The exemplary embodiments may determine candidate neighboring nodes for packet delivery using an LQI, may select a neighboring node for each packet to be transmitted among the determined candidate neighboring nodes, and may transmit the packet to the selected neighboring node, to reduce a failure rate in packet delivery and prevent a packet overload.

The exemplary embodiments may select a neighboring node for packet transmission among candidate neighboring nodes in consideration of a distance from a receiving node corresponding to a destination of a packet, to enable routing via a relatively short routing path.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A routing apparatus comprising:
a determining unit to determine, when a packet received from a first node is a data packet, M candidate neighboring nodes among second nodes different from the first node based on a link quality index (LQI) of the second nodes, wherein M is a natural number; and
a processor to select, based on a distance from a receiving node corresponding to a destination of the packet, one neighboring node among the M determined candidate neighboring nodes, and to transmit the packet to the selected neighboring node.

2. The apparatus of claim 1, wherein the processor transmits, when a first data packet is received from the first node and a second data packet different from the first data packet is received, the second data packet to a second neighboring node different from a first neighboring node transmitting the first data packet.

3. The apparatus of claim 1, wherein the processor selects a neighboring node having a relatively short distance from the receiving node among the M determined candidate neighboring nodes, and transmits the packet to the selected neighboring node.

4. The apparatus of claim 1, wherein the determining unit determines a second node having an LQI greater than or equal to a predetermined value, to be the candidate neighboring node.

5. The apparatus of claim 1, wherein the processor extracts, when the packet received from the first node is a data packet, at least one of an identification (ID) of the first node and a packet ID from the packet, and transmits an acknowledgement message comprising the extracted ID to the first node.

6. The apparatus of claim 1, further comprising:
an interface to generate, when a packet received from at least one node of the first node and the second node is a state message comprising a node ID, information about the at least one node based on the state message, and to store the generated information about the at least one node in a database.

7. The apparatus of claim 1, wherein the processor re-transmits, when the acknowledgement message to the packet fails to be received from the neighboring node transmitting the packet within a predetermined effective time, to the neighboring node, and when a number of re-transmission times is greater than or equal to a predetermined value, removes the neighboring node from the candidate neighboring nodes.

8. A routing method comprising:
determining, when a packet received from a first node is a data packet, M candidate neighboring nodes among second nodes different from the first node based on a link quality index (LQI) of the second nodes, wherein M is a natural number; and
selecting, based on a distance from a receiving node corresponding to a destination of the packet, one neighboring node among the M determined candidate neighboring nodes, and transmitting the packet to the selected neighboring node.

9. The method of claim 8, wherein the transmitting of the packet comprises, when a first data packet is received from the first node and a second data packet different from the first data packet is received, transmitting the second data packet to a second neighboring node different from a first neighboring node transmitting the first data packet.

10. The method of claim 8, wherein the transmitting of the packet comprises selecting a neighboring node having a relatively short distance from the receiving node among the M determined candidate neighboring nodes and transmitting the packet to the selected neighboring node.

11. The method of claim 8, wherein the determining of the candidate neighboring node comprises determining a second node having an LQI greater than or equal to a predetermined value to be the candidate neighboring node.

12. The method of claim 8, further comprising:
extracting, when the packet received from the first node is a data packet, at least one of an identification (ID) of the first node and a packet ID from the packet, and transmitting an acknowledgement message comprising the extracted ID to the first node.

13. The method of claim 8, further comprising:
generating, when a packet received from at least one node of the first node and the second node is a state message comprising a node ID, information about the at least one node based on the state message, and storing the generated information about the at least one node in a database.

14. The method of claim 8, further comprising:
re-transmitting, when the acknowledgement message to the packet fails to be received from the neighboring node transmitting the packet within a predetermined effective time, the packet to the neighboring node, and when a number of re-transmission times is greater than or equal to a predetermined value, removing the neighboring node from the candidate neighboring nodes.
